(19) United States
(12) Patent Application Publication
(10) Pub. No.: US 2026/0164270 A1
(43) Pub. Date: Jun. 11, 2026

(54) SUBSCRIBER ANOMALY DETECTION AND SCORING USING RAN NETWORK DATA

(71) Applicant: T-Mobile USA, Inc., Bellevue, WA (US)

(72) Inventor: Vasanth DHANARAJA, Silver Spring, MD (US)

(21) Appl. No.: 18/970,581

(22) Filed: Dec. 5, 2024

(51) Int. Cl. H04W 24/08; H04W 8/18

(52) U.S. Cl. CPC H04W 24/08; H04W 8/18

(57) ABSTRACT

Disclosed examples of performing subscriber anomaly detection and scoring using radio access technology (RAT) network data enable meaningful (and actionable) comparisons of different generations of wireless technology (e.g., 4G and 5G), despite widely-disparate key performance indicators (KPIs) for the different technologies. Dimensionality reduction across dozens of KPIs, for example using principal component analysis (PCA) to reduce to the two dimensions (eigenvectors) having the greatest impact on network performance variability. A distance from a centroid (or best scoring point) of the dimensionally-reduced cluster provides a first score factor. A second score factor accounts for any single KPI, in a KPI set for a subscriber, having a value outside of an acceptable range, so that such a KPI set cannot artificially receive a high score. The two score factors are combined into a composite score that provides a solid basis for analysis and better decision-making for network maintenance and upgrade actions.

### BACKGROUND

The evolution of telecommunications networks has introduced significant complexity into the management and analysis of subscriber network performance. Modern networks, such as fourth generation (4G) and fifth Generation (5G) cellular networks, support multiple radio access technologies (RATs) contemporaneously, such as 4G, 5G Non-Standalone (NSA), and 5G Standalone (SA)—each with distinct characteristics and performance metrics. As a result, network subscribers are each associated with a variety of Key Performance Indicators (KPIs), which may operate on different scales.

Subscriber network performance data is inherently complex due to the diversity of protocols and the varied nature of the data collected from different radio types. KPIs, such as Success Rates for Accessibility, Retainability, and Mobility, are analyzed within each radio type. Additional metrics include mobility KPIs within each network (intra-network) and across different networks (inter-network). KPIs vary significantly across network types, complicating direct comparisons and performance assessments.

For example, a publication by a leading cellular infrastructure provider states “5G networks require different benchmark measurements compared to 4G networks.” (Benchmark Measurements in 5G Networks, published by Ericsson, 2020, available at: www.ericsson.com/en/blog/2020/8/benchmark-measurements-in-5g-networks.) This poses challenges in achieving a coherent, unified assessment of subscriber experiences, as affected by network performance.

### SUMMARY

The following summary is provided to illustrate examples disclosed herein, but is not meant to limit all examples to any particular configuration or sequence of operations.

Solutions are disclosed that provide for subscriber anomaly detection and scoring using radio access technology (RAT) network data. Examples determine, for each wireless subscriber of a set of wireless subscribers using a wireless network, a subscriber key performance indicator (KPI) set, wherein each subscriber KPI set comprises at least three different relevant KPIs; perform, on each subscriber KPI set, dimensionality reduction to reduce each subscriber KPI set to a two-dimensional (2D) scoring point; determine, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point; determine, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold; combine, for each subscriber KPI set, the first score factor and the second score factor into a composite score for at least each wireless subscriber not having an anomalous subscriber KPI set; and generate, for a first wireless subscriber of a set of wireless subscribers, a first report comprising the composite score for the first wireless subscriber.

### BRIEF DESCRIPTION OF THE DRAWINGS

The disclosed examples are described below with reference to the accompanying drawing figures listed below, wherein:

FIG. 1 illustrates an exemplary architecture that advantageously provides subscriber anomaly detection and scoring using radio access technology (RAT) network data;

FIG. 2 illustrates further detail for an exemplary anomaly detection and scoring function of the architecture of FIG. 1;

FIG. 3 illustrates further detail for data cleanup of key performance indicators (KPIs), as may occur when using examples of the architecture of FIG. 1;

FIG. 4 illustrates further detail for scoring of RAT network data, as may occur when using examples of the architecture of FIG. 1;

FIGS. 5, 6, and 7 illustrate further detail for the scoring RAT network data, as described for FIG. 4;

FIG. 8 illustrates an exemplary report of anomaly detection and scoring results, as may be generated when using examples of the architecture of FIG. 1;

FIG. 9 illustrates a flowchart of exemplary operations associated with the architecture of FIG. 1; and

FIGS. 10A, 10B, 10C, and 10D, together, illustrate exemplary python code that performs an equivalent of the functionality described for the flowchart of FIG. 9 and the operations described for FIGS. 2-8;

FIG. 11 illustrates another flowchart of exemplary operations associated with the architecture of FIG. 1; and

FIG. 12 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Typically, 4G KPIs may be categorized into five categories: (1) accessibility, (2) retainability, (3) integrity, (4) availability, and (5) mobility. Accessibility KPIs may include RRC Connection Establishment, Random Access, Initial E-RAB Establishment Success Rate, RRC Connection Establishment Counters, Initial E-RAB Establishment Success Rate Counters, Added E-RAB Establishment Success Rate Counters, Added E-RAB Establishment Success Rate, and S1 Signaling Connection Establishment. Retainability KPIs may include MME Initiated E-RAB & UE Context Release with counters Description, UE Session Time, RBS Initiated E-RAB & UE Context Release with counters Description, MME & RBS Initiated UE Context Release Flow Chart, and MME & RBS Initiated E-RAB Release Flow Chart. Integrity KPIs may include EUTRAN Throughput KPIs, EUTRAN Latency KPIs, and EUTRAN Packet Loss KPIs. Availability KPIs may include Partial cell availability. Mobility KPIs may include X2 Based Handover Preparation and Execution, Intra RBS Handover Preparation and Execution, Intra Frequency Handover Preparation and Execution Counters, S1 Based Handover Preparation and Execution, Intra-frequency intra-LTE S1 and X2 Handover Flowchart, Inter Frequency Handover Preparation and Execution Counters, and Inter-frequency intra-LTE S1 and X2 Handover Flowchart.

Typically, 5G KPIs are grouped into three categories: (1) enhanced mobile broadband (eMBB), (2) ultra-reliable and low-latency communications (URLLC), and (3) massive machine type communications (mMTC). The eMBB KPIs may include Peak Data Rate, Peak Spectral Efficiency, Data rate experienced by User, Area Traffic Capacity, Average Spectral Efficiency, Energy Efficiency, and Mobility. The URLCC KPIs may include Reliability and may share (with eMBB) Latency (user plane) and Mobility Interruption Time. The mMTC KPIs may include Bandwidth (Maximum Aggregated System) and Connection Density.

KPIs may be used: (1) to monitor and optimize the radio network performance in order to provide better subscriber quality or to achieve better use of installed network resources; (2) to detect current unacceptable performance related issues in the cellular network, enabling the operator to take rapid actions to preserve the quality of the existing network services; and (3) to provide planners with the detailed information for configuring network parameters for optimum use. The challenge is then to unify these widely disparate KPIs, which are represented as values over time and in various statistical forms (e.g., mean, percentiles, outliers), in order to generate a coherent metric or score. A unified metric or score enables accurate comparison and effective performance management across different radio access technologies (RATs).

Disclosed examples of performing subscriber anomaly detection and scoring using RAT network data enable meaningful (and actionable) comparisons of different generations of wireless technology (e.g., 4G and 5G), despite widely-disparate KPIs for the different technologies. Dimensionality reduction across dozens of KPIs, for example using principal component analysis (PCA) to reduce to the two dimensions (eigenvectors) having the greatest impact on network performance variability. A distance from a centroid (or best scoring point) of the dimensionally-reduced cluster provides a first score factor. A second score factor accounts for any single KPI, in a KPI set for a subscriber, having a value outside of an acceptable range, so that such a KPI set cannot artificially receive a high score. The two score factors are combined into a composite score that provides a solid basis for analysis and better decision-making for network maintenance and upgrade actions.

Aspects of the disclosure improve the efficiency of providing wireless services, by enabling coherent, meaningful comparison of different wireless technology performance, even in the absence of a common set of KPIs. These advantageous results are accomplished, at least in part, by performing, on each subscriber KPI set, dimensionality reduction to reduce each subscriber KPI set to a two-dimensional (2D) scoring point.

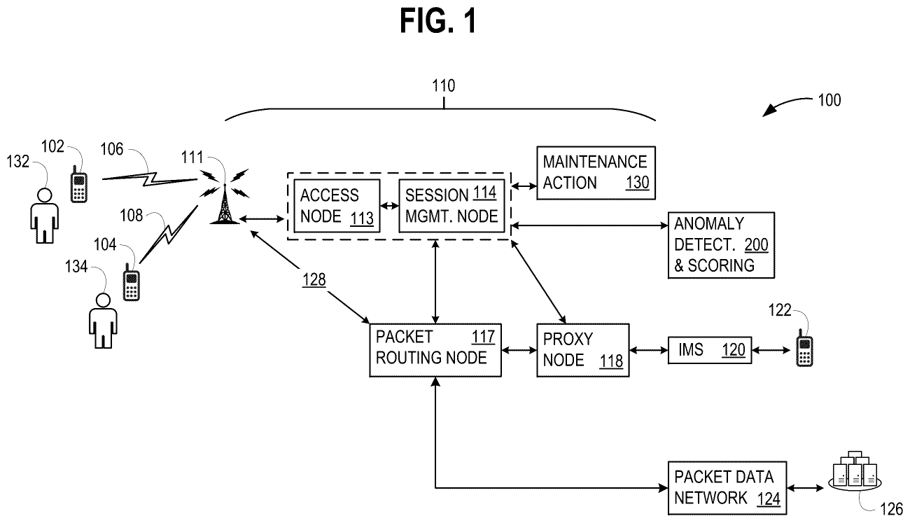

With reference now to the figures, FIG. 1 illustrates an exemplary architecture 100 that advantageously provides for subscriber anomaly detection and scoring using RAT network data. A wireless network 110 is illustrated that is serving a UE 102 for a wireless subscriber 132, and a UE 104 for a wireless subscriber 134. Each of UE 102 and UE 104 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 106 to communicate with a base station 111 of wireless network 110, such that base station 111 is the serving base station for UE 102 (providing the serving cell), and UE 104 uses an air interface 108 to communicate with base station 111. In some scenarios, base station 111 may be referred to as a radio access network (RAN). Wireless network 110 has an access node 113, a session management node 114, and other components (not shown). Wireless network 110 also has a packet routing node 117 and a proxy node 118. Access node 113 and session management node 114 are within a control plane of wireless network 110, and packet routing node 117 is within a data plane (a.k.a. user plane) of wireless network 110.

Base station 111 is in communication with access node 113 and packet routing node 117. Access node 113 is in communication with session management node 114, which is in communication with packet routing node 117, and proxy node 118. Packet routing node 117 is in communication with proxy node 118 and packet data network 124. In some 5G examples, base station 111 comprises a gNodeB (gNB), access node 113 comprises an access mobility function (AMF), session management node 114 comprises a session management function (SMF), and packet routing node 117 comprises a user plane function (UPF). In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using packet data network 124 (or IMS 120, in some examples). Data packets of data traffic 128 to/from UE 102 pass through at least base station 111 and packet routing node 117 on their way from/to packet data network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, and described more fully below in relation to the other figures, an anomaly detection and scoring function 200 analyzes KPIs of wireless network 110 for both wireless subscriber 132 and wireless subscriber 134 (among other wireless subscribers), in order to prioritize a plan for a maintenance or upgrade action 130, such as hardware or software maintenance or adding capacity. That is, the timing and focus of maintenance or upgrade action 130 may be optimized, based on the scoring results provided by anomaly detection and scoring function 200. In some examples, the different wireless technologies are 4G and 5G, or may even include 6G. In some examples, UE 102 and 104 are High-Speed Internet (HSI). In some examples, anomaly detection and scoring function 200 is provided as a cloud service.

In general, at least three categories of maintenance/upgrade actions are feasible: (1) investigate and mitigate poor network performance issues, (2) proactive subscriber support, and (3) resource allocation and planning. Investigating and mitigating poor network performance issues may include using the identified anomalies to target network sites or segments that are experiencing significant KPI issues. This allows for focused troubleshooting and potential hardware or software adjustments to improve performance. Proactive subscriber support may include reaching out to subscribers who are experiencing poor network performance as flagged by their KPIs. This proactive approach may help retain customers by showing that the network provider is aware of issues and working to resolve them. Resource allocation and planning may include allocating resources such as maintenance teams or budget more efficiently by prioritizing markets or locations with high anomaly scores. This ensures that areas with the most significant performance issues receive attention first, optimizing network reliability.

Although FIG. 1 and some of the following figures are described using an example of a cellular network, it should be understood that the teachings herein are applicable to other types of wireless networks. To benefit from the teachings herein, another wireless network, other than a cellular network, should use a wide range of KPIs that describe network performance, such that analysis of network performance is complicated by the wide disparities in KPIs. With such features, another type of wireless network, other than a cellular network, may also benefit from the disclosure herein.

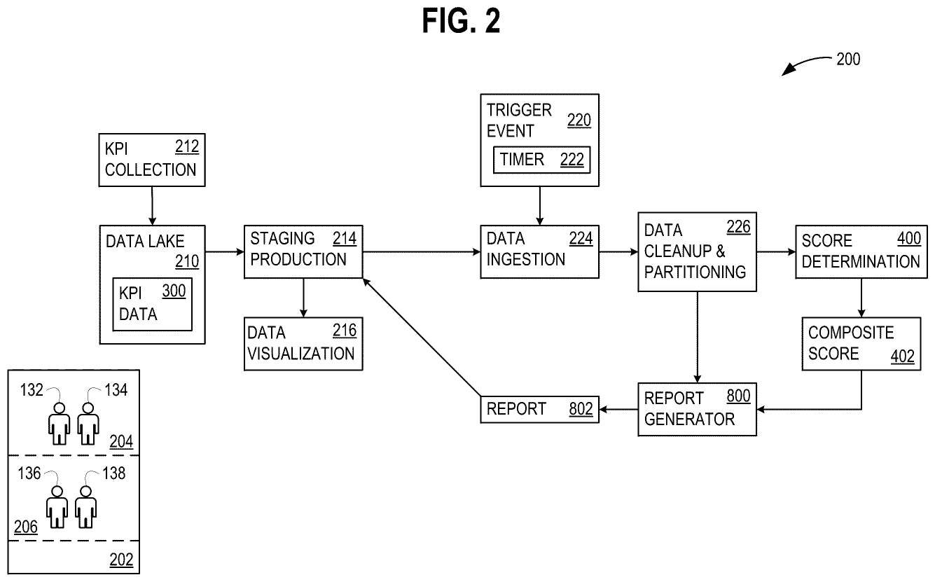

FIG. 2 illustrates further detail for anomaly detection and scoring function 200. Wireless subscriber 132 and wireless subscriber 134 are in a set of wireless subscribers 202, along with other wireless subscribers 136 and 138. A KPI collection function 212 collects KPI data 300 from RANs of wireless network 110, and stores KPI data 300 in a data lake 210, associated with UEs (e.g., UE 102 and UE 104). The association with the UEs is a proxy for association with wireless subscribers.

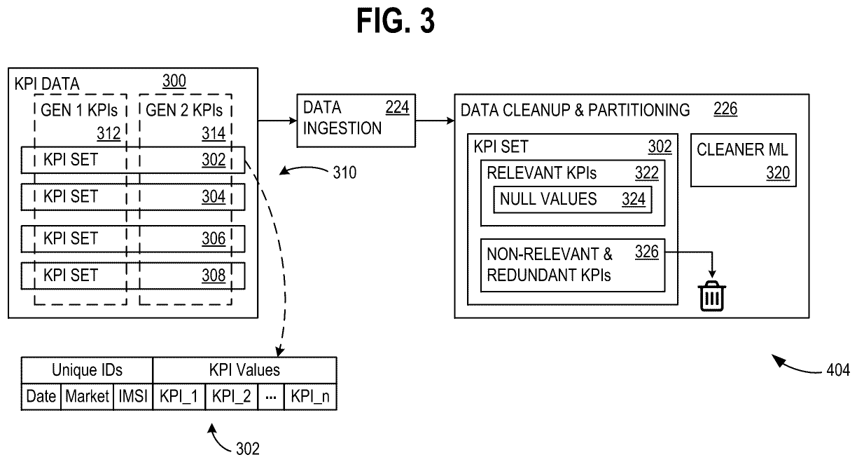

In some examples, KPI data 300 is partitioned, such as by geographic region (e.g., a cellular market or cellular site). For simplicity of presentation, however, he partitioning is illustrated among wireless subscribers 132-138. KPI data 300 for wireless subscriber 132 and wireless subscriber 134 is in a first partition 204, whereas KPI data 300 for wireless subscriber 136 and wireless subscriber 138 is in a second partition 206. Some examples use a different number of partitions. KPI data 300 is described in further detail in relation to FIG. 3.

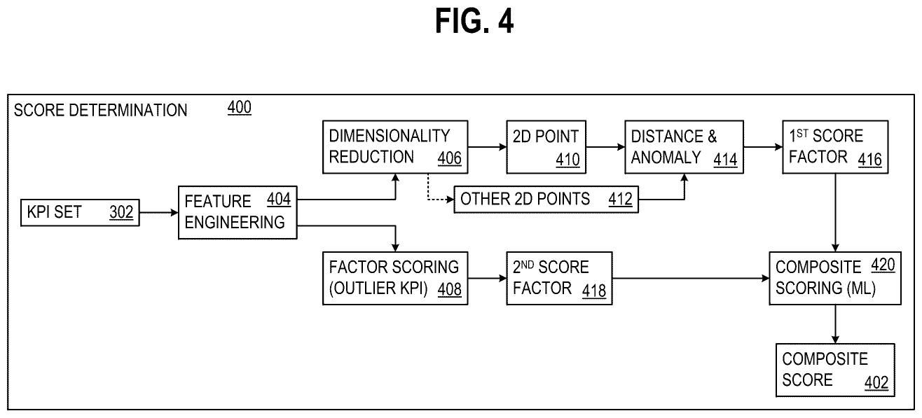

Staging and production tables 214 contains structured with KPI data 300 that is passed to a data ingestion function 224 that extracts/queries data from staging and production tables 214, possibly using Scala, python, or SQL (or another language), which then passes KPI data 300 to a data cleanup and partitioning function 226. Data cleanup and partitioning function 226 provides feature engineering that aggregates, fills in missing data, and other necessary actions. For example, data cleanup and partitioning function 226 may convert at least some of KPI data 300 to logarithmic values, which improves performance when different KPIs use widely differing native scales. The clean-up of KPI data 300 is described in further detail in relation to FIG. 2. KPI data 300 is then passed to a score determination function 400 that generates a composite score 402. The operation of score determination function 400 and generation of composite score 402 are described in further detail in relation to FIGS. 4-7. In some examples, the remainder of FIG. 2, starting from data ingestion function 224, through report generator 800 s provided in a python environment.

Feature engineering transforms existing features to improve the performance of an ML model by selecting, extracting, and transforming the most relevant features from the available data. In the context of machine learning (ML), a feature (also known as a variable or attribute) is an individual measurable property or characteristic of a data point that is used as input for an ML model. In the context herein, the relevant KPI's become the features. Features may be numerical, categorical, or text-based, and represent different aspects of the data that are relevant to the problem being solved. For example, in a data set of housing prices, features may include the number of bedrooms, the square footage, the location, and the age of the property.

A report generator 800 receives composite score 402, merges it with data from KPI data 300, and generates a report 802 for any (or each of) of wireless subscribers 132-138. Staging and production function 214 makes report 802 available for viewing by a data visualization function 216. In some examples, data lake 210, staging and production function 214, and data visualization function 216 are provided as cloud services. In some examples, a timer 222 provides a trigger event 220 to start the data ingestion process and generate report 802, although a user intervention may also be a trigger event 220. Timer may be set to a day, a week, a month, or another time frame.

FIG. 3 illustrates further detail for data cleanup and partitioning function 226. KPI data 300 has a collection of subscriber KPI sets 310, which includes a subscriber KPI set 302 for wireless subscriber 132 (i.e., UE 102), a subscriber KPI set 304 for wireless subscriber 134 (i.e., UE 104), a subscriber KPI set 306 for wireless subscriber 136, and a subscriber KPI set 308 for wireless subscriber 138. KPI data 300 has KPIs pertaining to multiple wireless technology generations, including a set of KPIs 312 for 5G and a set of KPIs 314 for 4G. Any of subscriber KPI set 302, 304, 306, and 308 may include KPI information from set of KPIs 312 and/or set of KPIs 314. That is, any of subscriber KPI set 302, 304, 306, and 308 may include both 4G and 5G KPI information.

An example of how subscriber KPI set 302 may be formatted is shown, showing Date, Market (used for partitioning), IMSI (identifying the UE and as a proxy, the wireless subscriber), and various KPI values, shown as KPI_1, KPI_2, and KPI_n. Data cleanup and partitioning function 226 identifies relevant KPIs 322 (which are further limited by eliminating redundancy) and non-relevant KPIs and redundant KPIs 326. Non-relevant KPIs and redundant KPIs 326 are eliminated from further use in the process. In some examples, relevant KPIs 322 include: NR_RRC_SETUP_FAILURES, NR_RRC_RE_ESTABLISHMENT_FAILURES, NR_NGAP_INITIAL_CONTEXT_SETUP_FAILURES, LTE_RRC_SETUP_FAILURES, LTE_RRC_RE_ESTABLISHMENT_FAILURES, LTE_INITIAL_CONTEXT_SETUP_FAILURES, ERAB_DROPS, LSR_5G_EN_DC_SGNB_ADDITION_FAILURES, LSR_5G_EN_DC_SGNB_DROPS, NR_DROPPED_CONNECTIONS, NR_QOS_FLOW_FAILED_ATTEMPTS, and NR_QOS_FLOW_DROPS.

Relevant KPIs 322 may have null values 324 (i.e., missing values) that to be filled in, for example by estimation or imputation, in order to avoid introducing errors later in the process. Some examples of data cleanup and partitioning function 226 employ ML, or artificial intelligence (AI), which is used synonymously with ML herein. Some examples of data cleanup and partitioning function 226 may be referred to as a data cleaner ML 320, including the feature engineering portion identified previously. By the conclusion (output) of data cleanup and partitioning function 226, non-relevant KPIs and redundant KPIs 326 have been identified and/or null values 324 have been filled in. Subscriber KPI set 302 and subscriber KPI set 304 are also placed into a partition different than subscriber KPI set 306 and subscriber KPI set 308, when partitioning is used. The functionality provided in FIG. 3 may be collectively referred to as feature engineering 404.

FIG. 4 illustrates further detail for score determination function 400. After feature engineering 404 (the activities described above for FIG. 3), subscriber KPI set 302 is provided to dimensionality reduction 406, which performs dimensionality reduction to reduce subscriber KPI set 302, even if having up to dozens of different KPI values, to a 2D scoring point 410. Dimensionality reduction 406 also reduces other subscriber KPI sets, (e.g., subscriber KPI set 304) to generate other 2D scoring points 412 (each of which is equivalent to 2D scoring point 410). Some examples use PCA.

PCA is a linear dimensionality reduction technique that transforms multi-dimensional data into a smaller coordinate system with fewer dimensions. PCA may be defined as an orthogonal linear transformation on a real inner product space that transforms a data set to a new coordinate system such that the greatest variance by some scalar projection of the data lies along a first coordinate axis (called the first principal component) and the second greatest variance lies along a second coordinate axis. The principal dimensionality components may be considered to be eigenvectors of the multi-dimensional data set's covariance matrix. PCA dimensionality reduction is often performed using eigen decomposition of the data set's covariance matrix, or singular value decomposition of the data set.

A distance and anomaly detection function 414 generates a (first) score factor 416 for at least each subscriber KPI set that does not produce an anomalous 2D scoring point (e.g., subscriber KPI set 302). Some examples also produce score factor 416 for subscriber KPI sets that do produce anomalous 2D scoring points, and address anomalous KPI values using factor scoring 408. In some examples, isolation forest, which is an algorithm for data anomaly detection using binary trees, is used to identify anomalous 2D scoring points.

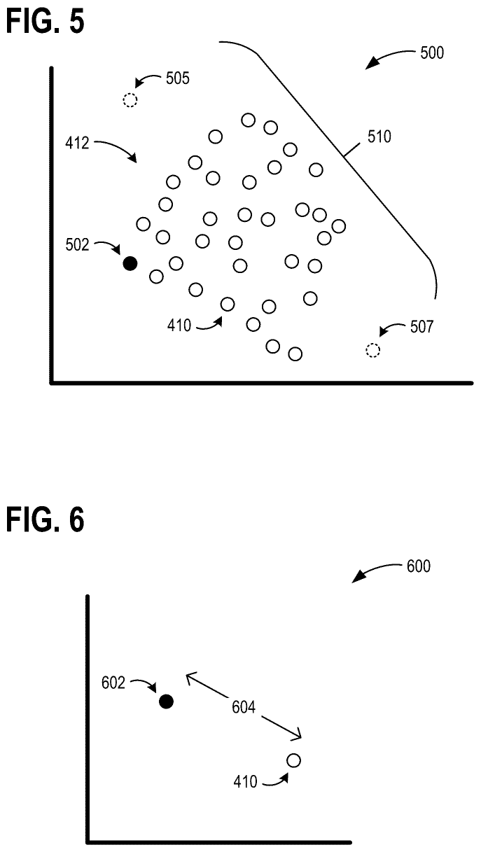

Turning briefly to FIGS. 5 and 6, FIG. 5 illustrates 2D scoring points 510 on a scatter plot 500 for a partition of KPI data 300, which includes 2D scoring point 410 and other 2D scoring points 412. An anomalous 2D point 505 and another anomalous 2D point 507, represent the dimensionality reduction of anomalous subscriber KPI sets. A centroid 502 of 2D scoring points 510 provides a reference point for measuring how close 2D scoring point 410 is to “normal” performance. In some examples, centroid 502 is determined using a clustering algorithm that identifies the focal point of a 2D scoring points 510. In some examples, centroid 502 is instead determined by setting all KPIs to ideal values (i.e., perfect network performance) and identifying the resulting 2D scoring point.

FIG. 6 illustrates determination of a distance 604 of 2D scoring point 410 from centroid 502 (illustrated as a best score scoring point 602, generated using the ideal KPI values, as described above) on a 2D plot 600. That is, distance 604 may be from a cluster centroid or an ideal KPI 2D scoring point. One option is to calculate distance 604 as the Euclidean distance from best score scoring point 602 or centroid 502, and assigning a score inversely related to distance 604. For example, a 2D scoring point close to best score scoring point 602 or centroid 502 has a low distance 604 and so is given a high score. A 2D scoring point further away (having a higher low distance 604) is given a lower score. In some examples, any 2D point having a distance 604 greater than some threshold is given a score of 0. As illustrated, 2D scoring point 410 earns a 50 for its score factor 416.

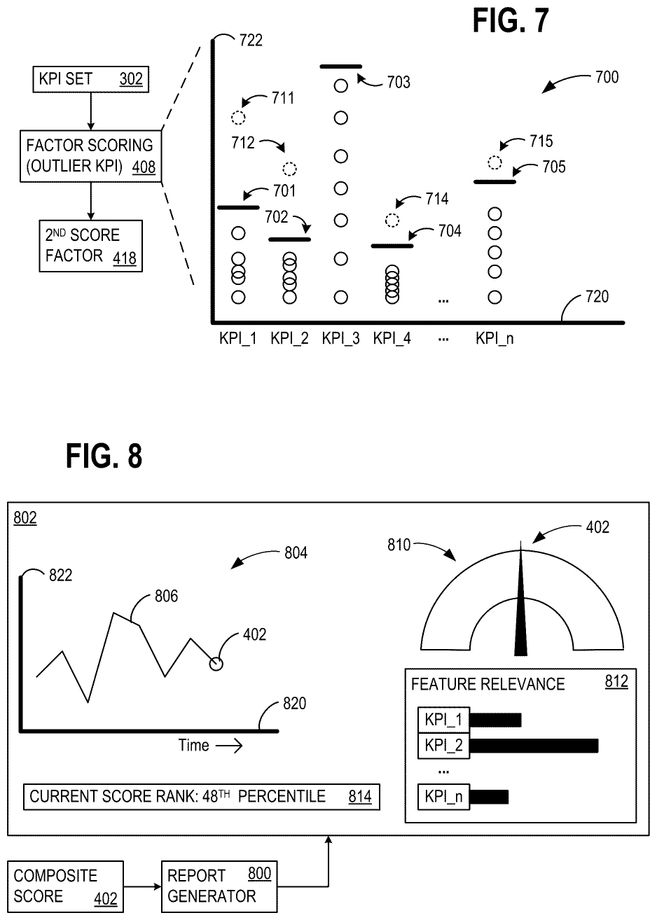

Returning to FIG. 4, subscriber KPI set 302 is also provided to factor scoring 408, which generates a (second) score factor 418, as described later in relation to FIG. 7. Score factor 416 and score factor 418 are provided to a composite scoring ML model 420, which generates composite score 402. The generation of composite score 402 is such that, if either of score factor 416 and score factor 418 indicate poor network performance (i.e., are low when 0 is poor performance and 100 is ideal performance on a scale of 0 to 100), then composite score 402 also necessarily indicates poor network performance. Although only just an example, a multiplicative product of score factor 416 and score factor 418 will be zero if either score factor 416 or score factor 418 is zero. A geometric mean of score factor 416 and score factor 418 satisfies such a requirement.

Turning now to FIG. 7, the assignment of score factor 418 is shown in further detail, for some examples. A set of different KPIs is shown, separated on a horizontal axis 720, with its value shown as a height along a vertical axis 722. The different KPIs include KPI_1, KPI_2, a KPI_3, a KPI_4, and KPI_n. Anomalous point are assigned a second score factor 418 of zero. Some examples use an isolation forest to identify anomalous points. As a notional explanation, KPI-specific thresholds are shown to illustrate whether a KPI value is too extreme, although some examples may not use explicit thresholding. For KPI_1, a corresponding KPI-specific threshold 701 enables determination that KPI value 711 is extreme (i.e., network performance is poor). That is, for KPI_1, KPI value 711 indicates that the network performance is worse (for the subscriber KPI set that includes KPI value 711) than would be experienced if KPI value 711 had met KPI-specific threshold 701.

For KPI_2, a corresponding KPI-specific threshold 702 enables determination that KPI value 712 is extreme. For KPI_3, a corresponding KPI-specific threshold 703 enables determination whether any KPI value is extreme (none are, as illustrated). For KPI_4, a corresponding KPI-specific threshold 704 enables determination that KPI value 714 is extreme, and for KPI_n, a corresponding KPI-specific threshold 705 enables determination that KPI value 715 is extreme. For a single KPI, for example KPI_n, 715 receives the worst score of zero, the next point receives the next worst score, and so on. The set of second score factor 418 is normalized from 0 to 100 with the most extreme receiving zero and the least extreme values receiving a score of 100. This is performed for each KPI.

FIG. 8 illustrates further detail for report 802. Composite score 402 is shown, in report 802, in a trend indication 804 that plots composite score 402 on a timeline 806 along a time axis 820 versus a score value axis 822. Report 802 also shows composite score 402 in a dial indicator graphic 810 for a quick visual assessment. A ranking 814 of composite score 402, relative to composite scored for other wireless subscribers in the same partition of KPI data 300 (e.g., wireless subscriber 134), is included in some examples. This may be a raw numeric value (“X of Y”), a percentile, or another ranking indication.

Some examples of report 802 also include an indication 812 of various KPI's relevance to composite score 402. This is shown in FIG. 8 as a bar graph, but could be another indication. In some examples, relevance for all KPIs is shown, although in some examples, relevance for only a select set of KPIs is shown (e.g., the most relevant KPIs). A version of report 802 may be generated for other wireless subscribers 136-138.

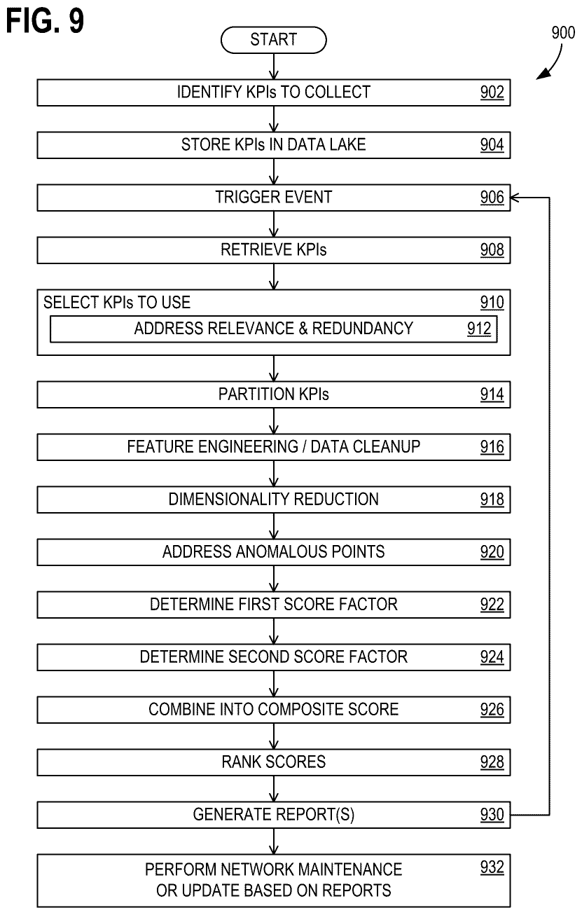

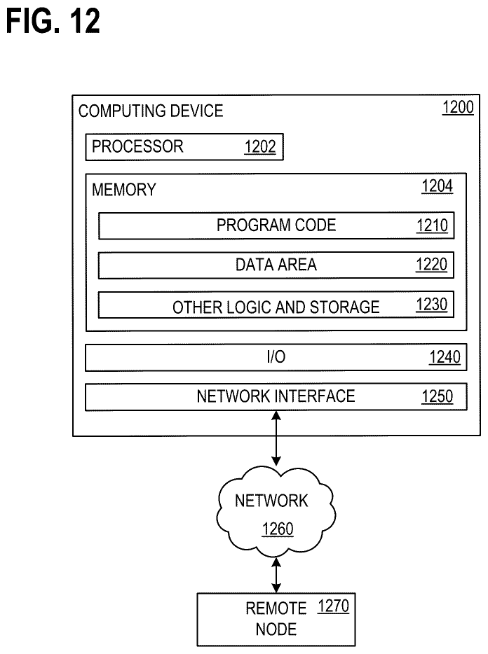

FIG. 9 illustrates a flowchart 900 of exemplary operations associated with examples of architecture 100. In some examples, at least a portion of flowchart 900 may be performed using one or more computing devices 1200 of FIG. 12. Flowchart 900 commences with identifying set of KPIs 312 for one generation of wireless technology (e.g., 5G) and identifying set of KPIs 314 for another generation of wireless technology (e.g., 4G or 6G) in operation 902. Operation 904 stores KPI data 300 for set of wireless subscribers 202 in data lake 210.

Trigger event 220 occurs in operation 906, and operations 908-932 are all in response to trigger event 220. Trigger event 220 may be a lapse of timer 222, set for some period such as a day, or a week, or a month. KPI data 300, for set of wireless subscribers 202, is retrieved from data lake 210 in operation 908.

Operation 910 determines subscriber KPI set 302 for each wireless subscriber (e.g., wireless subscriber 132 or 134) of set of wireless subscribers 202 that are using wireless network 110. In some examples, operation 910 is performed once, prior to operation 906. Each subscriber KPI set 302 comprises at least three different relevant KPIs, and may include KPIs in both set of KPIs 312 and set of KPIs 314. Operation 910 may be performed using operation 912, which filters KPIs for relevance and redundancy, to eliminate non-relevant KPIs and redundant KPIs from subscriber KPI sets 310.

Subscriber KPI sets 310 are partitioned in operation 914, possibly by geographical location, such as a cellular market region or a set of cellular sites (down to a single cellular site). Operations 916-932 are then performed within each partition of subscriber KPI sets 310. For example, performing the dimensionality reduction and determining score factor 416, as described below, is performed separately for each partition—when partitioning is used.

Operation 916 performs feature engineering and data cleanup, such as filling any null values in subscriber KPI sets 310 and normalizing values of subscriber KPI sets 310 (e.g., normalizing each KPI value to a range of 0 to 100). Dimensionality reduction is performed on each subscriber KPI set (e.g., subscriber KPI set 302) in operation 918, to reduce each subscriber KPI set to its representative 2D scoring point (e.g., 2D scoring point 410).

Operation 920 identifies and removes anomalous subscriber KPI sets from the score determination, for example using an isolation forest algorithm. In some examples, this comprises setting score factor 416 of anomalous subscriber KPI sets to zero. In some examples, anomalous subscriber KPI sets are instead addressed by score factor 418. Operation 922 determines score factor 416 using distance 604 of 2D scoring point 410 from best score scoring point 602 (or centroid 502) for each subscriber KPI set. In some examples, score factor 416 indicates a superior wireless network experience for the wireless subscriber (e.g., wireless subscriber 132 or 134) as inversely related to distance 604 of 2D scoring point 410 from best score scoring point 602. In some examples, best score scoring point 602 comprises an ideal score with ideal KPIs.

Distance 604 of 2D scoring point 410 from best score scoring point 602 may be a Euclidean distance. Some examples use a logarithmic scale for distances. In such examples, score factor 416 is inversely related to distance 604 of 2D scoring point 410 from best score scoring point 602.

Operation 924 determines score factor 418 using values of subscriber KPI set 302 for each subscriber KPI set. Score factor 418 indicates an inferior wireless network experience for the wireless subscriber (e.g., wireless subscriber 132 or 134) upon any KPI of subscriber KPI set 302 indicating network performance worse than a corresponding KPI-specific threshold 701 (or 702-705). Some examples use factor scoring 408 to determine score factor 418. When the scoring is ordered such that a high score indicates good network performance and a low score indicates poor network performance (as opposed to a golf-type score in which lower numbers are superior), score factor 418 is reduced if at least one KPI of subscriber KPI set 302 indicates network performance worse than KPI-specific threshold 701 (or 702-705).

Score factor 416 and score factor 418 are combined into composite score 402, for at least each wireless subscriber (e.g., wireless subscriber 132 or 134) not having an anomalous subscriber KPI set, in operation 926. Operation 928 ranks each composite score 402 within each partition of subscriber KPI sets 310, and operation 930 generates reports for wireless subscribers, such as report 802 for wireless subscriber 132. Report 802 includes composite score 402 for wireless subscriber 132. In some examples, report 802 further comprises indication 812, for multiple KPIs, of the KPI's relevance to composite score 402, and/or trend indication 804 of composite score 402 for the wireless subscriber (e.g., wireless subscriber 132 or 134) over time. In some examples, report 802 also includes ranking 814 of composite score 402 for wireless subscriber 132 among other wireless subscribers in set of wireless subscribers 202 (or partition 204).

Based on at least composite score 402 for wireless subscriber 132 indicating poorer network experience than indicated by composite score 402 for wireless subscriber 134, operation 932 performs maintenance or upgrade action 130.

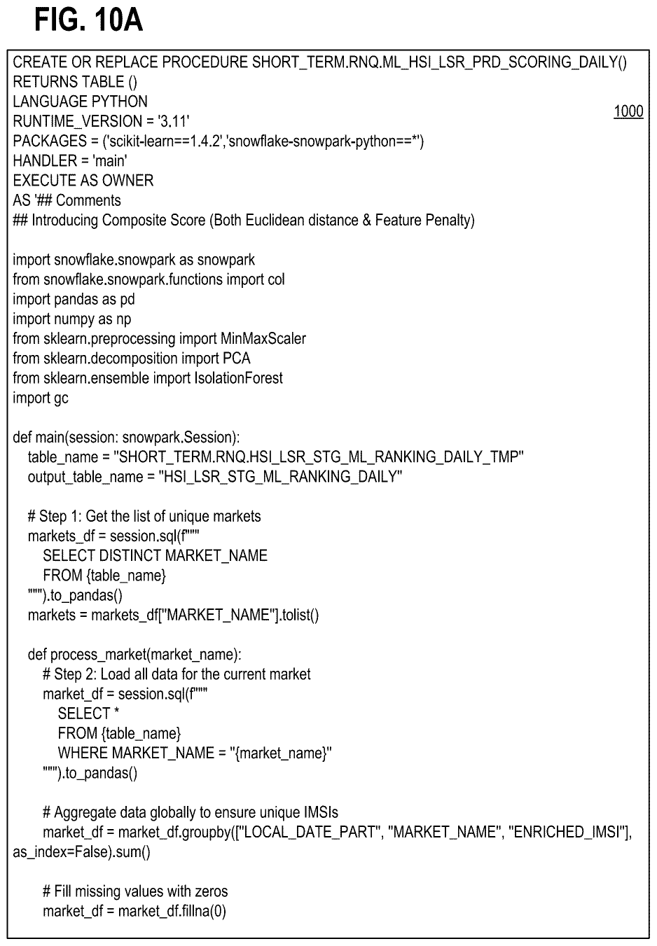

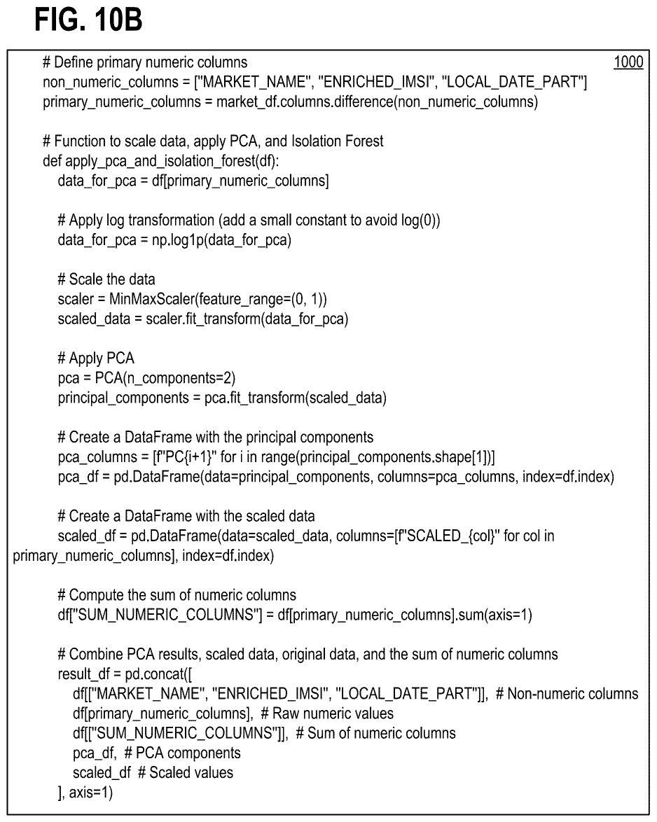

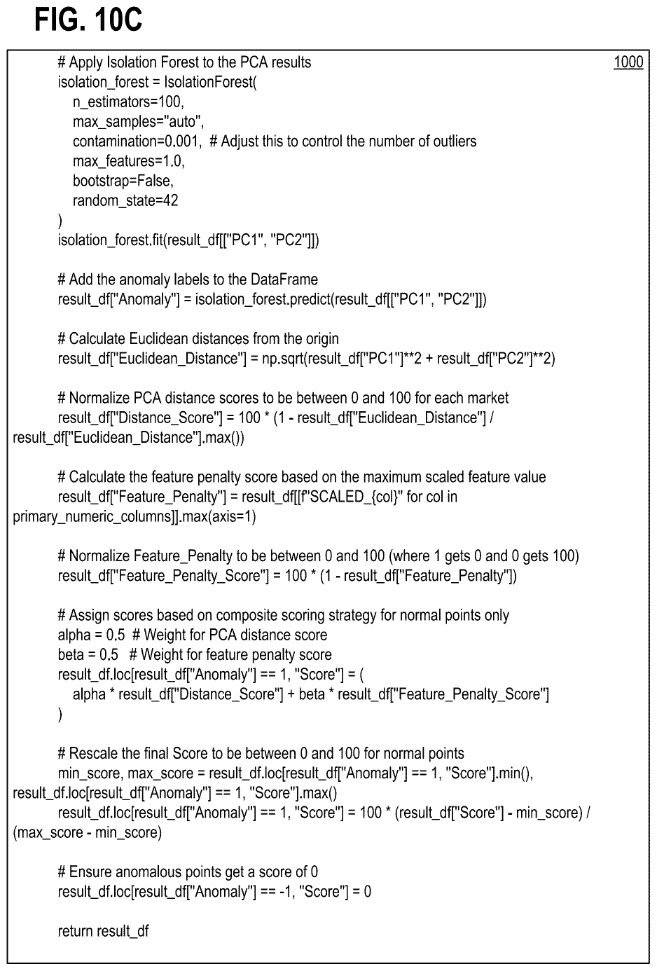

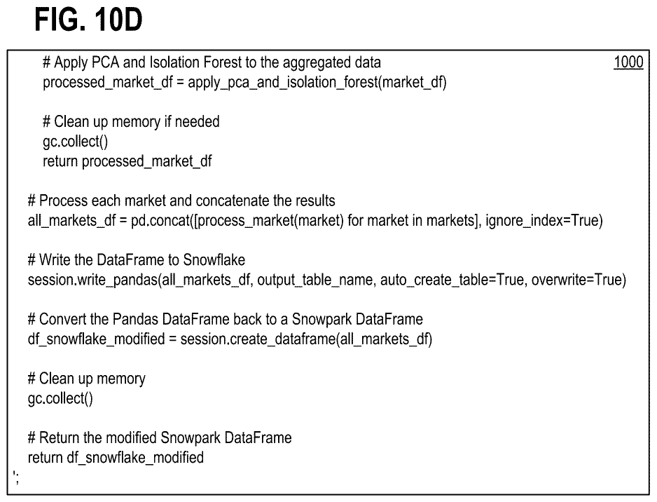

FIGS. 10A, 10B, 10C, and 10D, together, illustrate exemplary python code that performs an equivalent of the functionality described for the flowchart of FIG. 9 and the operations described for FIGS. 2-8. The python code illustrated is provided as an example of just one of multiple ways to perform the inventive concepts described herein.

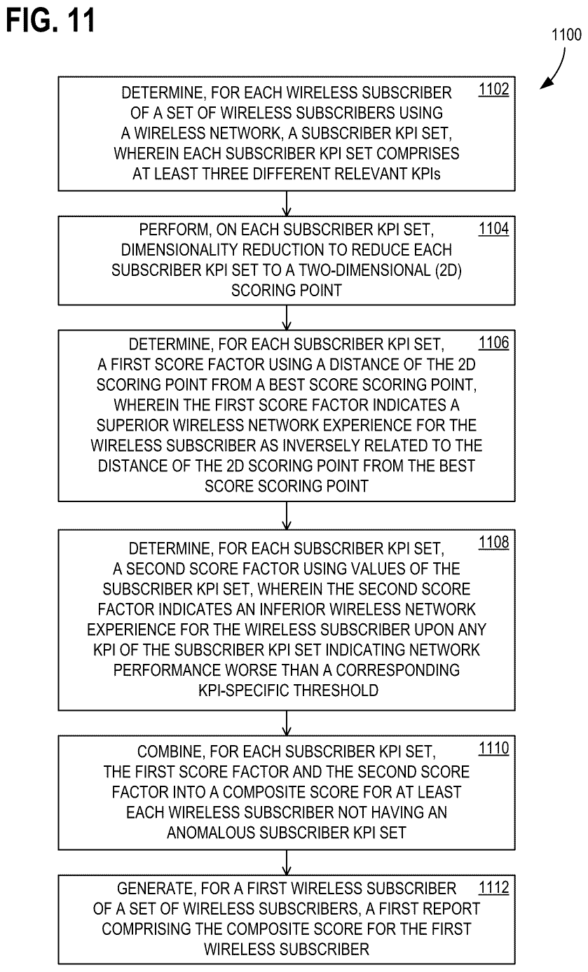

FIG. 11 illustrates a flowchart 1100 of exemplary operations associated with architecture 110. In some examples, at least a portion of flowchart 1100 may be performed using one or more computing devices 1200 of FIG. 12. Flowchart 1100 commences with operation 1102, which includes determining, for each wireless subscriber of a set of wireless subscribers using a wireless network, a subscriber KPI set, wherein each subscriber KPI set comprises at least three different relevant KPIs.

Operation 1104 includes performing, on each subscriber KPI set, dimensionality reduction to reduce each subscriber KPI set to a 2D scoring point. Operation 1106 includes determining, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point.

Operation 1108 includes determining, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold. Operation 1110 includes combining the first score factor and the second score factor into a composite score for at least each wireless subscriber not having an anomalous subscriber KPI set. Operation 1112 includes generating, for a first wireless subscriber of a set of wireless subscribers, a first report comprising the composite score for the first wireless subscriber.

FIG. 12 illustrates a block diagram of computing device 1200 that may be used as any component described herein that may require computational or storage capacity. Computing device 1200 has at least a processor 1202 and a memory 1204 that holds program code 1210, data area 1220, and other logic and storage 1230. Memory 1204 is any device allowing information, such as computer executable instructions and/or other data, to be stored and retrieved. For example, memory 1204 may include one or more random access memory (RAM) modules, flash memory modules, hard disks, solid-state disks, persistent memory devices, and/or optical disks. Program code 1210 comprises computer executable instructions and computer executable components including instructions used to perform operations described herein. Data area 1220 holds data used to perform operations described herein. Memory 1204 also includes other logic and storage 1230 that performs or facilitates other functions disclosed herein or otherwise required of computing device 1200. An input/output (I/O) component 1240 facilitates receiving input from users and other devices and generating displays for users and outputs for other devices. A network interface 1250 permits communication over external network 1260 with a remote node 1270, which may represent another implementation of computing device 1200. For example, a remote node 1270 may represent another of the above-noted nodes within architecture 100.

### Additional Examples

An example system comprises: a processor; and a computer-readable medium storing instructions that are operative upon execution by the processor to: determine, for each wireless subscriber of a set of wireless subscribers using a wireless network, a subscriber KPI set, wherein each subscriber KPI set comprises at least three different relevant KPIs; perform, on each subscriber KPI set, dimensionality reduction to reduce each subscriber KPI set to a 2D scoring point; determine, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point; determine, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold; combine, for each subscriber KPI set, the first score factor and the second score factor into a composite score for at least each wireless subscriber not having an anomalous subscriber KPI set; and generate, for a first wireless subscriber of a set of wireless subscribers, a first report comprising the composite score for the first wireless subscriber.

An example method of wireless communication comprises: determining, for each wireless subscriber of a set of wireless subscribers using a wireless network, a subscriber KPI set, wherein each subscriber KPI set comprises at least three different relevant KPIs; performing, on each subscriber KPI set, dimensionality reduction to reduce each subscriber KPI set to a 2D scoring point; determining, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point; determining, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold; combining the first score factor and the second score factor into a composite score for at least each wireless subscriber not having an anomalous subscriber KPI set; and generating, for a first wireless subscriber of a set of wireless subscribers, a first report comprising the composite score for the first wireless subscriber.

One or more example computer storage devices has computer-executable instructions stored thereon, which, upon execution by a computer, cause the computer to perform operations comprising: determining, for each wireless subscriber of a set of wireless subscribers using a wireless network, a subscriber KPI set, wherein each subscriber KPI set comprises at least three different relevant KPIs; performing, on each subscriber KPI set, dimensionality reduction to reduce each subscriber KPI set to a 2D scoring point; determining, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point; determining, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold; combining the first score factor and the second score factor into a composite score for at least each wireless subscriber not having an anomalous subscriber KPI set; and generating, for a first wireless subscriber of a set of wireless subscribers, a first report comprising the composite score for the first wireless subscriber.

Alternatively, or in addition to the other examples described herein, examples include any combination of the following:
the wireless network comprises a cellular network;
based on at least the composite score for the first wireless subscriber indicating poorer network experience than indicated by a composite score for a second wireless subscriber, a maintenance or upgrade action on the wireless network;
identifying a first set of KPIs for a first generation of wireless technology;
identifying a second set of KPIs for a second generation of wireless technology;
the subscriber KPI sets for the set of wireless subscribers includes KPIs in both the first set of KPIs and the second set of KPIs;
storing KPI data for the set of wireless subscribers in a data lake;
retrieving the KPI data for the set of wireless subscribers from the data lake;
filtering KPIs to eliminate, from the subscriber KPI sets, non-relevant KPIs and redundant KPIs;
partitioning the subscriber KPI sets by geographical location;
performing the dimensionality reduction and determining the first score factor is performed separately for each partition;
filling any null values in the subscriber KPI sets;
normalizing values of the subscriber KPI sets;
identifying and removing anomalous subscriber KPI sets from the score determination;
ranking each composite score within each partition of the subscriber KPI sets;
the dimensionality reduction comprises PCA;
the first report further comprises an indication, for multiple KPIs, of the KPI's relevance to the composite score;
the first report further comprises a trend indication, over time, of the composite score for the first wireless subscriber;
the first report further comprises a ranking of the composite score for the first wireless subscriber among other wireless subscribers in the set of wireless subscribers;
the relevant KPIs include: NR_RRC_SETUP_FAILURES, NR_RRC_RE_ESTABLISHMENT_FAILURES, NR_NGAP_INITIAL_CONTEXT_SETUP_FAILURES, LTE_RRC_SETUP_FAILURES, LTE_RRC_RE_ESTABLISHMENT_FAILURES, LTE_INITIAL_CONTEXT_SETUP_FAILURES, ERAB_DROPS, LSR_5G_EN_DC_SGNB_ADDITION_FAILURES, LSR_5G_EN_DC_SGNB_DROPS, NR_DROPPED_CONNECTIONS, NR_QOS_FLOW_FAILED_ATTEMPTS, and NR_QOS_FLOW_DROPS;
each wireless subscriber of the set of wireless subscribers uses an HSI device;
wireless subscriber of the set of wireless subscribers uses an eMBB device, or an FWA device, or an IoT device;
the first generation of wireless technology comprises 5G technology;
the second generation of wireless technology comprises 4G technology;
identifying relevant and non-redundant KPIs using a relevance ML model;
the trigger events comprise lapses of a periodic timer;
the periodic timer is set for a day, or a week, or a month;
partitioning the subscriber KPI sets by geographical location comprises partitioning by a cellular market region or a set of cellular sites (down to a single cellular site);
the null values in the subscriber KPI sets are missing data points;
the best score scoring point comprises an ideal score with ideal KPIs;
the best score scoring point comprises a centroid of the 2D scoring points of the partition of the set of wireless subscribers;
identifying the anomalous subscriber KPI sets using an isolation forest algorithm;
removing the anomalous subscriber KPI sets from the score determination comprises setting the first score factor of anomalous subscriber KPI sets to zero;
the distance of the 2D scoring point from the best score scoring point comprises a Euclidean distance;
the first score factor is inversely related to the distance of the 2D scoring point from the best score scoring point;
the second score factor is reduced if at least one KPI of the subscriber KPI set indicates network performance worse than a KPI-specific threshold;
combining the first score factor and the second score factor into the composite score uses a multiplicative product of the first score factor and the second score factor (e.g., geometric mean or uses a composite scoring ML model);
the composite score for a wireless subscriber is zero if either of the first score factor or the second score factor is zero; and
each wireless subscriber having an anomalous subscriber KPI set has a composite score of zero, if the composite score is determined for that wireless subscriber.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
determining, for each wireless subscriber of a set of wireless subscribers using a wireless network, a subscriber KPI set, wherein each subscriber KPI set comprises at least three different relevant KPIs;
performing, on each subscriber KPI set, dimensionality reduction to reduce each subscriber KPI set to a two-dimensional (2D) scoring point;
determining, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point;
determining, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold;
combining the first score factor and the second score factor into a composite score for at least each wireless subscriber not having an anomalous subscriber KPI set; and
generating, for a first wireless subscriber of a set of wireless subscribers, a first report comprising the composite score for the first wireless subscriber.

2. The method of claim 1, further comprising:
based on at least the composite score for the first wireless subscriber indicating poorer network experience than indicated by a composite score for a second wireless subscriber, performing a maintenance or upgrade action on the wireless network.

3. The method of claim 1, further comprising:
identifying a first set of key performance indicators (KPIs) for a first generation of wireless technology; and
identifying a second set of KPIs for a second generation of wireless technology, wherein the subscriber KPI sets for the set of wireless subscribers includes KPIs in both the first set of KPIs and the second set of KPIs.

4. The method of claim 1, further comprising:
storing KPI data for the set of wireless subscribers in a data lake;
retrieving the KPI data for the set of wireless subscribers from the data lake;
filtering KPIs to eliminate, from the subscriber KPI sets, non-relevant KPIs and redundant KPIs;
partitioning the subscriber KPI sets by geographical location, wherein performing the dimensionality reduction and determining the first score factor is performed separately for each partition;
filling any null values in the subscriber KPI sets;
normalizing values of the subscriber KPI sets;
identifying and removing anomalous subscriber KPI sets from the score determination; and
ranking each composite score within each partition of the subscriber KPI sets.

5. The method of claim 1, wherein the dimensionality reduction comprises principal component analysis (PCA).

6. The method of claim 1, wherein the first report further comprises:
an indication, for multiple KPIs, of the KPI's relevance to the composite score; or
a trend indication, over time, of the composite score for the first wireless subscriber; or
a ranking of the composite score for the first wireless subscriber among other wireless subscribers in the set of wireless subscribers.

7. The method of claim 1, wherein the relevant KPIs include:
NR_RRC_SETUP_FAILURES, NR_RRC_RE_ESTABLISHMENT_FAILURES, NR_NGAP_INITIAL_CONTEXT_SETUP_FAILURES, LTE_RRC_SETUP_FAILURES, LTE_RRC_RE_ESTABLISHMENT_FAILURES, LTE_INITIAL_CONTEXT_SETUP_FAILURES, ERAB_DROPS, LSR_5G_EN_DC_SGNB_ADDITION_FAILURES, LSR_5G_EN_DC_SGNB_DROPS, NR_DROPPED_CONNECTIONS, NR_QOS_FLOW_FAILED_ATTEMPTS, and NR_QOS_FLOW_DROPS.

8. The method of claim 1, wherein each wireless subscriber of the set of wireless subscribers uses a High-Speed Internet (HSI) device.

9. A system comprising:
a processor; and
a computer-readable medium storing instructions that are operative upon execution by the processor to:
determine, for each wireless subscriber of a set of wireless subscribers using a wireless network, a subscriber KPI set, wherein each subscriber KPI set comprises at least three different relevant KPIs;
perform, on each subscriber KPI set, dimensionality reduction to reduce each subscriber KPI set to a two-dimensional (2D) scoring point;
determine, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point;
determine, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold;
combine, for each subscriber KPI set, the first score factor and the second score factor into a composite score for at least each wireless subscriber not having an anomalous subscriber KPI set; and
generate, for a first wireless subscriber of a set of wireless subscribers, a first report comprising the composite score for the first wireless subscriber.

10. The system of claim 9, wherein the instructions are further operative to:
store KPI data for the set of wireless subscribers in a data lake;
retrieve the KPI data for the set of wireless subscribers from the data lake;
filter KPIs to eliminate, from the subscriber KPI sets, non-relevant KPIs and redundant KPIs;
partition the subscriber KPI sets by geographical location, wherein performing the dimensionality reduction and determining the first score factor is performed separately for each partition;
fill any null values in the subscriber KPI sets;
normalize values of the subscriber KPI sets;
identify and remove anomalous subscriber KPI sets from the score determination; and
ranking each composite score within each partition of the subscriber KPI sets.

11. The system of claim 9, wherein the dimensionality reduction comprises principal component analysis (PCA).

12. The system of claim 9, wherein the first report further comprises:
an indication, for multiple KPIs, of the KPI's relevance to the composite score; or
a trend indication, over time, of the composite score for the first wireless subscriber; or
a ranking of the composite score for the first wireless subscriber among other wireless subscribers in the set of wireless subscribers.

13. The system of claim 9, wherein the relevant KPIs include at least 3 KPIs selected from the list consisting of: NR_RRC_SETUP_FAILURES, NR_RRC_RE_ESTABLISHMENT_FAILURES, NR_NGAP_INITIAL_CONTEXT_SETUP_FAILURES, LTE_RRC_SETUP_FAILURES, LTE_RRC_RE_ESTABLISHMENT_FAILURES, LTE_INITIAL_CONTEXT_SETUP_FAILURES, ERAB_DROPS, LSR_5G_EN_DC_SGNB_ADDITION_FAILURES, LSR_5G_EN_DC_SGNB_DROPS, NR_DROPPED_CONNECTIONS, NR_QOS_FLOW_FAILED_ATTEMPTS, and NR_QOS_FLOW_DROPS.

14. The system of claim 9, wherein each wireless subscriber of the set of wireless subscribers uses a High-Speed Internet (HSI) device.

15. One or more computer storage devices having computer-executable instructions stored thereon, which, upon execution by a computer, cause the computer to perform operations comprising:
determining, for each wireless subscriber of a set of wireless subscribers using a wireless network, a subscriber KPI set, wherein each subscriber KPI set comprises at least three different relevant KPIs;
performing, on each subscriber KPI set, dimensionality reduction to reduce each subscriber KPI set to a two-dimensional (2D) scoring point;
determining, for each subscriber KPI set, a first score factor using a distance of the 2D scoring point from a best score scoring point, wherein the first score factor indicates a superior wireless network experience for the wireless subscriber as inversely related to the distance of the 2D scoring point from the best score scoring point;
determining, for each subscriber KPI set, a second score factor using values of the subscriber KPI set, wherein the second score factor indicates an inferior wireless network experience for the wireless subscriber upon any KPI of the subscriber KPI set indicating network performance worse than a corresponding KPI-specific threshold;
combining the first score factor and the second score factor into a composite score for at least each wireless subscriber not having an anomalous subscriber KPI set; and
generating, for a first wireless subscriber of a set of wireless subscribers, a first report comprising the composite score for the first wireless subscriber.

16. The one or more computer storage devices of claim 15, wherein the operations further comprise:
storing KPI data for the set of wireless subscribers in a data lake;
retrieving the KPI data for the set of wireless subscribers from the data lake;
filtering KPIs to eliminate, from the subscriber KPI sets, non-relevant KPIs and redundant KPIs;
partitioning the subscriber KPI sets by geographical location, wherein performing the dimensionality reduction and determining the first score factor is performed separately for each partition;
filling any null values in the subscriber KPI sets;
normalizing values of the subscriber KPI sets;
identifying and removing anomalous subscriber KPI sets from the score determination; and
ranking each composite score within each partition of the subscriber KPI sets.

17. The one or more computer storage devices of claim 15, wherein the dimensionality reduction comprises principal component analysis (PCA).

18. The one or more computer storage devices of claim 15, wherein the first report further comprises:
an indication, for multiple KPIs, of the KPI's relevance to the composite score; or
a trend indication, over time, of the composite score for the first wireless subscriber; or
a ranking of the composite score for the first wireless subscriber among other wireless subscribers in the set of wireless subscribers.

19. The one or more computer storage devices of claim 15, wherein the relevant KPIs include: NR_RRC_SETUP_FAILURES, NR_RRC_RE_ESTABLISHMENT_FAILURES, NR_NGAP_INITIAL_CONTEXT_SETUP_FAILURES, LTE_RRC_SETUP_FAILURES, LTE_RRC_RE_ESTABLISHMENT_FAILURES, LTE_INITIAL_CONTEXT_SETUP_FAILURES, ERAB_DROPS, LSR_5G_EN_DC_SGNB_ADDITION_FAILURES, LSR_5G_EN_DC_SGNB_DROPS, NR_DROPPED_CONNECTIONS, NR_QOS_FLOW_FAILED_ATTEMPTS, and NR_QOS_FLOW_DROPS.

20. The one or more computer storage devices of claim 15, wherein the first score factor is inversely related to the distance of the 2D scoring point from the best score scoring point, and wherein the second score factor is reduced if at least one KPI of the subscriber KPI set indicates network performance worse than its corresponding KPI-specific threshold.
